(19) United States
(12) Patent Application Publication
(10) Pub. No.: US 2013/0159193 A1
(43) Pub. Date: Jun. 20, 2013

(54) METHOD AND APPARATUS FOR DELIVERING CONTENT IN A COMMUNICATION SYSTEM

(71) Applicants: Polly Tang, San Diego, CA (US); Alexander Medvinsky, San Diego, CA (US); Petr Peterka, San Diego, CA (US)

(72) Inventors: Polly Tang, San Diego, CA (US); Alexander Medvinsky, San Diego, CA (US); Petr Peterka, San Diego, CA (US)

(73) Assignee: GENERAL INSTRUMENT CORPORATION, Horsham, PA (US)

(21) Appl. No.: 13/329,437

(22) Filed: Dec. 19, 2011

(51) Int. Cl. G06Q 30/00; H04L 9/14

(52) U.S. Cl. 705/51

(57) ABSTRACT

An embodiment of the present invention provides a method of transferring content within a system having a credit managing device, a content providing device and a user device. The method includes: registering the user device with the credit managing device; providing a universal credit to the user device from the credit managing device; providing encrypted content and a pre-rights generator from the content providing device to the user device at a first time without consuming the universal credit; generating a decryption key from the pre-rights generator a second time after the first time; and decrypting, via the decryption key, the encrypted content at the user device and consuming a portion of the universal credit.

### BACKGROUND

The present invention relates to the field of digital communication systems, and in particular to delivering digital content in a digital communication system.

A variety of conventional methods are available for purchase and rental of digital content (e.g., movies, audio, etc.) For example, digital content may be purchased or rented at a retail establishment. As another example, digital content may be rented from a kiosk. As a further example, digital content may be accessed via a monthly subscription service, where a multiplicity of content is provided for a set subscription fee. Content may be provided via a multiplicity of methods, download, disc, removable storage device, etc.

Conventional systems for purchasing, renting and accessing digital content (e.g. movies, audio, etc.) typically involve purchasing or renting the content or subscribing and paying for access to the content prior to accessing the content. As an example, following the purchase of or subscription for the content, the content may be downloaded for viewing. The amount of time for downloading the content varies based upon the size of the content and upon the speed of the communication network and associated devices. In many cases, access to content may be significantly delayed as a result of the time required for downloading content following the purchase or rental of the content.

Additionally, some conventional systems require a device to be connected to a communications network in order to purchase, download and access content.

What is needed is improved methods for delivering digital content.

### BRIEF SUMMARY

The present invention provides a communications system for providing access to content via a universal credit. After registration with a credit managing device and prior to consumption of the universal credit, a user device may download a pre-rights generator and encrypted content from a content providing device. A decryption key may be generated for decrypting encrypted content in conjunction with consumption of the universal credit and delivery of unencrypted content.

In accordance with an embodiment of the present invention, a method is provided for transferring content within a system having a credit managing device, a content providing device and a user device. The method includes: registering the user device with the credit managing device; providing a universal credit to the user device from the credit managing device; providing encrypted content and a pre-rights generator from the content providing device to the user device at a first time without consuming the universal credit; generating a decryption key from the pre-rights generator a second time after the first time; and decrypting, via the decryption key, the encrypted content at the user device and consuming a portion of the universal credit.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1A is a block diagram illustration of an example communication system, in accordance with an embodiment of the present invention;

FIG. 1B is a block diagram illustration of the example communication system described with reference to FIG. 1A where a user device is no longer connected to communications network, in accordance with an embodiment of the present invention;

FIG. 2 is a block diagram illustration of an example content providing device as described with reference to FIGS. 1A-B, in accordance with an embodiment of the present invention;

FIG. 3 is a block diagram illustration of an example credit managing device as described with reference to FIGS. 1A-B, in accordance with an embodiment of the present invention;

FIG. 4 is a block diagram illustration of an example user device as described with reference to FIGS. 1A-B, in accordance with an embodiment of the present invention;

FIG. 5A is a signal flow diagram illustrating event and communication timing for operations associated with universal credit and content access, in accordance with an aspect of the present invention.

FIG. 5B is an extension of the signal flow diagram of FIG. 5A illustrating event and communication timing for operations associated with universal credit and content access, in accordance with an aspect of the present invention.

FIG. 6 is a logic flow diagram illustrating an example method for providing unencrypted content associated with a request for the content, in accordance with an embodiment of the present invention.

### DETAILED DESCRIPTION

In accordance with embodiments of the present invention, a communication system is presented for providing content to a user. The content is provided via a user device that is capable of registering with a content provider and purchasing a universal credit. The user device may receive and store a pre-rights generator and encrypted content prior to consumption of the universal credit. A decryption key for decrypting encrypted content may be generated via the pre-rights generator. The user device may provide unencrypted content with sufficient universal credit while connected to a communications network or while not connected to a communications network.

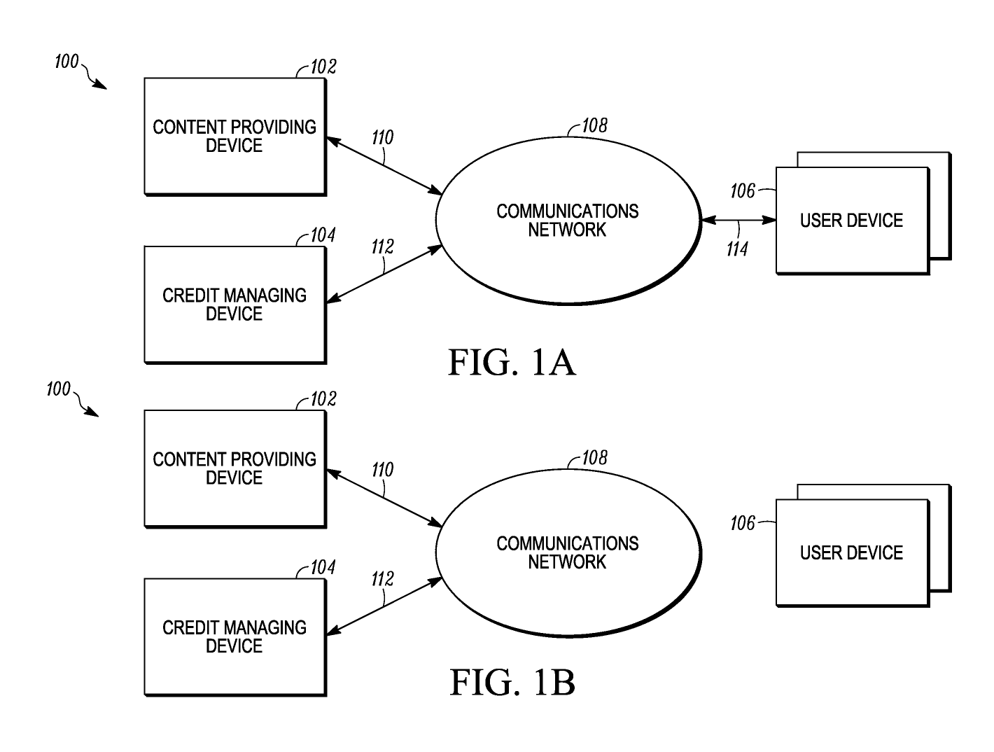

An example system and method for obtaining content in accordance with embodiments of the present invention will now be describe in greater detail with reference to FIGS. 1A-6.

FIG. 1A is a block diagram illustration of an example communication system 100, in accordance with an embodiment of the present invention. The communication system 100 includes a content providing device 102, a credit managing device 104, a user device 106 and a communications network 108. Each of the elements of the communication system 100 are illustrated as individual devices, however, in some embodiments of the present invention, the content providing device 102 and the credit managing device 104 may be combined as a unitary device. Further, in some embodiments at least one of the content providing device 102, the credit managing device 104 and the user device 106 may be implemented as a computer having stored therein tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a tangible computer-readable medium. Combinations of the above should also be included within the scope of tangible computer-readable media.

The content providing device 102 is arranged to bi-directionally communicate with the communications network 108 via a communication channel 110. The credit managing device 104 is arranged to bi-directionally communicate with the communications network 108 via a communication channel 112. The user device 106 is arranged to bi-directionally communicate with the communications network 108 via a communication channel 114. Any of the communication channel 110, the communication channel 112 and the communication channel 114 may be wired or wireless. The user device 106 is arranged to bi-directionally communicate with the content providing device 102 via the communication channel 110, the communications network 108 and the communication channel 114. The user device 106 is arranged to bi-directionally communicate with the credit managing device 104 via the communication channel 112, the communications network 108 and the communication channel 114.

The communication system 100 provides management and delivery of content to a user (not shown). For example, a user sitting at a computing device may seek to view a movie with the movie content provided to user via the communication system 100.

The content providing device 102 provides storage, management and delivery of content. For example, the content providing device 102 may store content (e.g., movies, audio, etc.) for delivery to a user for access by the user (e.g., to watch a movie).

The credit managing device 104 provides management of universal credits. For example, a user may purchase a credit to be used in exchange for access to content (e.g., watch a movie).

The user device 106 provides management and delivery of content to a user. For example, as a non-limiting example, the user device 106 may be any video display device which the user may use as an interface for downloading content (e.g., movies), purchasing credit and viewing content (e.g., movies), such as a smartphone, a laptop computer, a desktop computer, a tablet computer, or a set top box for use with a cable or satellite communication system.

The communications network 108 provides bi-directional communications between communications devices associated with the communications network 108. For example, the communications network 108 may be configured as the Internet or a cable television system.

A universal credit provides accounting associated with tracking and managing credits. As a non-limiting example, a universal credit may be considered analogous to a pre-paid debit card, wherein the card is initialized with a credit amount which may be debited in exchange for receipt of products and services.

In order to obtain a universal credit, the user device 106 registers with the credit managing device 104. In response to the user device 106 registering with the credit managing device 104, the credit managing device 104 provides a universal credit to the user device 106.

The user device 106 receives and stores encrypted content and a pre-rights generator from the content providing device 102 without consuming the universal credit. Encrypted content is content which has been encrypted or secured in order to restrict access to authorized entities. A pre-rights generator enables generation of rights associated with the encrypted content prior to use of the encrypted content.

After the user device 106 has received and stored the encrypted content and the pre-rights generator, the user device 106 generates a decryption key from the pre-rights generator. The user device 106 then uses the decryption key to decrypt the encrypted content and generate unencrypted content, and in doing so consumes a portion of the universal credit.

Communication between the user device 106 and the content providing device 102 and the credit managing device 104 via the communication channel 114, the communications network 108, the communication channel 110 and the communication channel 112 may be performed in a secure fashion. As a non-limiting example, secure communications may be performed via Secure Sockets Layer (SSL).

SSL is a cryptographic protocol that provides secure communications over networks. A common implementation for SSL is Internet applications including web browsing and electronic mail. Another common application for SSL is video distribution for cable television. SSL enables client/server applications to securely communicate across a network. SSL is designed to prevent unauthorized eavesdropping, tampering and message forgery. SSL uses cryptographic techniques to provide secure communications between a client and a server. SSL provides (or incorporates) authentication procedures for verifying client and server identity. SSL supports unilateral authentication, where only the server is authenticated, and bilateral authentication, where the client and server are both authenticated.

Communication via SSL includes algorithm negotiation, certificate verification, key exchange and data transfer. For SSL algorithm negotiation, a client requests a secure connection with a server and communicates a list of supported cryptographic algorithms to the server. The server selects the most secure cryptographic algorithm from the supplied list and communicates the selection to the client.

For SSL certificate verification, the server communicates its identification to the client in the form of a digital certificate. The digital certificate contains the server name, a trusted certificate authority (CA) and the server's public encryption key. The client then communicates with the trusted CA to confirm the identity of the server. For bilateral SSL authentication, the server verifies the identity of the client via a trusted CA in a similar manner with the client communicating its digital certificate, trusted CA and public encryption key.

For SSL key exchange, the server and client exchange keys for the encryption and decryption of the data which is to be transferred. For SSL data transfer, client and server use previously exchanged encryption/decryption keys for secure transfer of data. While not impenetrable, SSL does provide a highly secure transfer of information.

For purposes of illustrating the principles of the present invention, and not intending to limit the invention in any way, it may be assumed that the user device 106 is a computer device located in a user's home. Furthermore, it may be assumed that the content providing device 102 is a service center containing a library of movies available for access via download. Furthermore, it may be assumed that the credit managing device 104 is a server associated with a credit management bureau used for managing credit.

In an example embodiment, a user may seek to download, from the content providing device 102, fifty movies for potential access. Downloading the fifty movies requires a significant amount of time, and as a result, the user may seek to download the fifty movies at night or off-hours when the user device 106 is not actively being used. At the time of the downloading, the user may download the fifty movies without incurring consumption of credit or incurring an expense for downloading the fifty movies. At a later time and with sufficient credit, the user may select to view one of the downloaded fifty movies without having to wait for movie to be downloaded.

Furthermore, a user seeking to watch one of the fifty downloaded movies but with insufficient credit to watch the movie, may purchase additional credit from the credit managing device 104. After purchasing additional sufficient credit for viewing the movie, content is decrypted by the user device 106 and presented for viewing by user.

Furthermore, the communication system 100 provides convenient access to a movie by a user. A movie may be downloaded prior to access by the user without consuming credit. Following the download, the movie may be viewed with sufficient credit at any time without the user experiencing the time needed for downloading of the movie.

The communication system 100 depicted in FIG. 1A illustrates a system in which the user device 106 is operable to register and download encrypted content prior to consumption of universal credit. Furthermore, with consumption of universal credit, the user device may generate decryption key for decrypting encrypted content for delivery as unencrypted content.

FIG. 1B is a block diagram illustration of the communication system 100, described with reference to FIG. 1A, where the user device 106 is no longer connected to the communications network 108, in accordance with an embodiment of the present invention. In FIG. 1B, the user device 106 is not connected to the communications network 108 via the communication channel 114 as described with reference to FIG. 1A. The user device 106, with sufficient universal credit, may generate an associated decryption key associated with encrypted content previously stored on the user device, decrypt the encrypted content using the decryption key, and provide the decrypted (now unencrypted) content to a user. As an result, the user device 106 enables viewing of a prior downloaded movie even though the user device 106 is not connected to the communications network 108. Thus, the user device 106 may operate to generate a decryption key, decrypt encrypted content, and provide for consumption of a portion of a universal credit while not connected to the communications network 108.

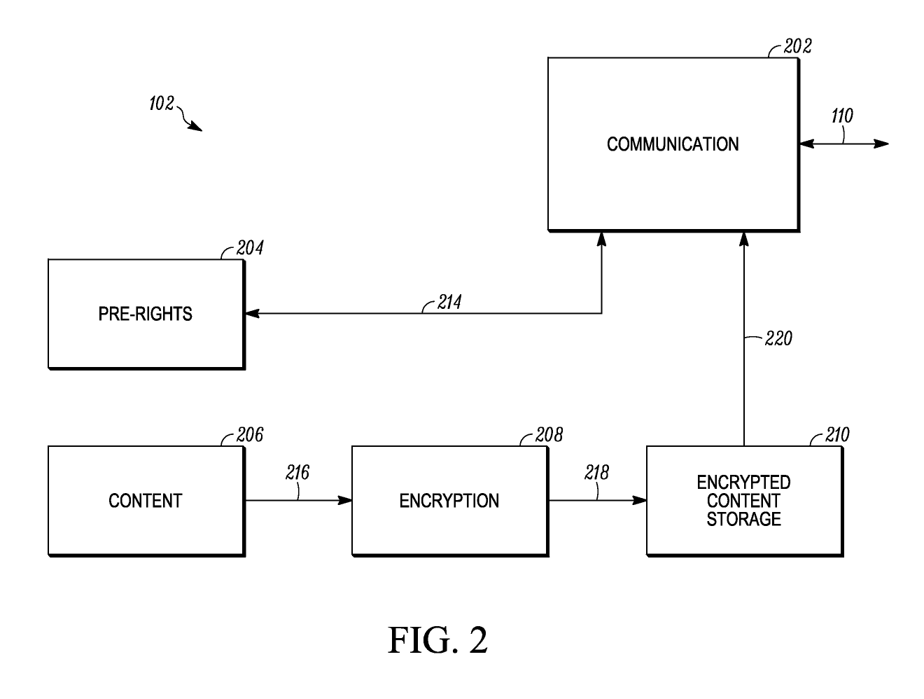

FIG. 2 is a block diagram illustration of the content providing device 102 as described with reference to FIGS. 1A-B, in accordance with an embodiment of the present invention.

The content providing device 102 includes a communication portion 202, a pre-rights portion 204, a content portion 206, an encryption portion 208, and an encrypted content storage portion 210. Each of the elements of the content providing device 102 are illustrated as individual components, however, in some embodiments, at least two of the communication portion 202, the pre-rights portion 204, the content portion 206, the encryption portion 208, the encrypted content storage portion 210 may be combined as a unitary device. Further, in some embodiments at least one of the communication portion 202, the pre-rights portion 204, the content portion 206, the encryption portion 208, the encrypted content storage portion 210 may be implemented as a computer having stored therein tangible computer-readable media for carrying or having computer-executable instructions or data structures stored thereon.

The communication portion 202 is arranged to bi-directionally communicate with the communications network 108 (not shown in FIG. 2) via the communication channel 110 and to bi-directionally communicate with the pre-rights portion 204 via a communication channel 214. The communication portion 202 is additionally arranged to receive encrypted content from the encrypted content storage portion 210 via a communication channel 220. The encrypted content storage portion 210 is additionally arranged to receive encrypted content from the encryption portion 208 via a communication channel 218. The encryption portion 208 is additionally arranged to receive content from the content portion 206 via a communication channel 216.

The communication portion 202 provides communication between components local to the content providing device 102 and external devices, such as the user device 106. Non-limiting examples for communication methods which the communication portion 202 may support include Internet and wireless.

The pre-rights portion 204 creates a pre-rights generator and includes information and functionality associated with decryption of downloaded content, access rights associated with the content, and pricing of downloaded content. The pre-rights portion 204 maintains, and provides to user devices such as the user device 106, a customer-specific pre-rights generator comprising a pre-rights generator file. The pre-rights generator file is a customer-specific file which includes information associated with performing pre-rights generation. A content decryption key for decrypting content is a non-limiting example of information associated with the pre-rights generator file. The pre-rights portion 204 also receives key requests from user devices, such as the user device 106. In response to receiving a key request from a user device, the pre-rights portion 204 conveys a key reply back to the user device. The key reply includes content identifications for content and associated rights. As a non-limiting example, the associated rights may include the price of the content. The pre-rights generator includes an expiration time, identifying an expiration time after which the respective content expires and may not be accessed, a key list, which includes a listing of keys, and a rights list, which includes content identification, associated rights, a key identification, which identifies which key to use and an associated cost. The pre-rights generator file is protected during download via session keys. For example, the pre-rights portion 204 may provide a decryption key for decryption of a movie for viewing by a user. The pre-rights generation file may expire following a pre-determined expiration time.

The content portion 206 provides a source of content. Non-limiting examples of content include movies, audio, pictures, images and books. For example, a user may seek to download and view content (e.g., a movie) from the content portion 206.

The encryption portion 208 encrypts content. For example, the encryption portion 208 may encrypt a movie such that it is maintained in a secure manner.

The encrypted content storage portion 210 stores encrypted content. For example, an encrypted movie may be stored via the encrypted content storage portion 210 and later retrieved from the encrypted content storage portion 210 for viewing.

In operation, the content providing device 102 receives requests for content from external entities, such as the user device 106, via the communication channel 110. In response to receiving a request for content from an external entity, the pre-rights portion 204 creates a pre-rights generator and communicates the pre-rights generator to the external entity via the communication channel 214, the communication portion 202 and the communication channel 110. Furthermore, in response to the request for content, the requested content, if not already encrypted, is delivered via the communication channel 216 from the content portion 206 to the encryption portion 208 for encryption. The encryption portion 208 encrypts the content and delivers, via the communication channel 218, the encrypted content to the encrypted content storage portion 210 for storage. The encrypted content then is delivered to the external entity via the communication channel 220, the communication portion 202 and the communication channel 110. Encrypted content stored in the encrypted content storage portion 210 may periodically be re-encrypted with new keys in order to aid in securely maintaining the content.

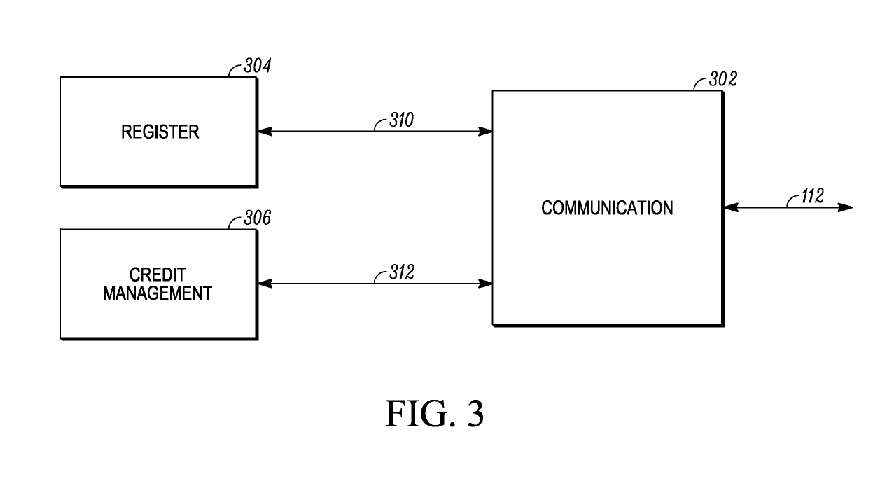

FIG. 3 is a block diagram illustration of the credit managing device 104 as described with reference to FIGS. 1A-B, in accordance with an embodiment of the present invention.

The credit managing device 104 is operable to perform registration and management of universal credit and includes a communication portion 302, a registering portion 304 and a credit managing portion 306.

Communication portion 302 communicates with external entities, such as user device 106, via a communication channel 112. The registering portion 304 is arranged to bi-directionally communicate with the communication portion 302 via a communication channel 310. The credit managing portion 306 is arranged to bi-directionally communicate with the communication portion 302 via the communication channel 312.

The communication portion 302 provides bi-directional communications between entities associated with the credit managing device 104 and external entities (not shown in FIG. 3). For example, the communication portion 302 may bi-directionally communicate, with external entities (not shown in FIG. 3), such as the user device 106, registration information and credit management information associated with a movie. Non-limiting examples for communication methods which the communication portion 302 may support include Internet and wireless.

The registering portion 304 provides registration capabilities via communication with external entities. For example, a user may seek to register with the registering portion 304 in order to register for downloading and viewing a movie.

The credit managing portion 306 provides management operations associated with a universal credit. For example, a user may purchase credit from the credit managing portion 306 for purposes of viewing a movie.

In operation, the communication portion 302 of the credit managing device 104 receives a registration request from an external entity, such as the user device 106, via the communication channel 112. The credit managing device 104 then routes the registration request to the registering portion 304 via the communication channel 310. The registering portion 304 verifies a valid registration request, and in response to verifying the request conveys registration information to the external entity via the communication channel 310, the communication portion 302 and the communication channel 112.

Furthermore, the credit managing device 104 receives, via the communication channel 112 and the communication portion 302, communication associated with a universal credit from external entities. Non-limiting examples for communication associated with a universal credit include requests for purchase of an initial credit, requests for purchase of additional credit and universal credit accounting updates. Communication associated with a universal credit is communicated to the credit managing portion 306 via the communication channel 312. The credit managing portion 306 receives and processes universal credit communications. Furthermore, the credit managing portion 306 communicates responses to universal credit communications to external entities via the communication channel 312, the communication portion 302 and the communication channel 112.

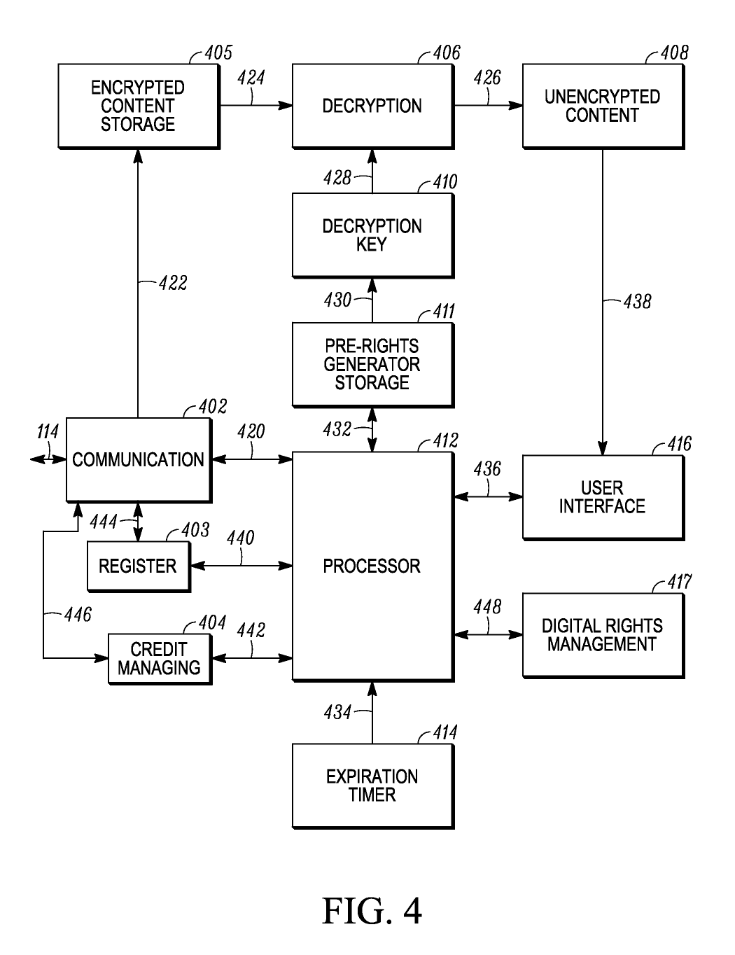

FIG. 4 is a block diagram illustration of the user device 106 as described with reference to FIGS. 1A-B, in accordance with an embodiment of the present invention. The user device 106 is operable for providing a user interface for delivery of content. Furthermore, the user device may register and purchase a universal credit, may download pre-rights generator and encrypted content, and may generate a decryption key for performing decryption of encrypted content for delivery of content to user interface, which decryption key generation and decryption of encrypted content consumes the universal credit.

The user device 106 includes a communication portion 402, a registering portion 403, a credit managing portion 404, an encrypted content storage 405, a decryption portion 406, an unencrypted content portion 408, a decryption key portion 410, a pre-rights generator storage 411, a processor portion 412, an expiration timer 414, a user interface 416 and a digital rights management portion 417. Each of the elements of the user device 106 are illustrated as individual components, however, in some embodiments of the present invention at least two of the communication portion 402, the encrypted content storage 405, the decryption portion 406, the unencrypted content portion 408, the decryption key portion 410, the pre-rights generator storage 411, the processor portion 412, the expiration timer 414 and the user interface 416 may be combined as a unitary device.

The registering portion 403 is arranged to bi-directionally communicate with the processor portion 412 via a communication channel 440 and with communication portion 402 via a communication channel 444. The credit managing portion 404 is arranged to bi-directionally communicate with the processor portion 412 via a communication channel 442 and with the communication portion 402 via a communication channel 446. The digital rights management portion 417 is arranged to bi-directionally communicate with the processor portion 412 via a communication channel 448.

The encrypted content storage 405 receives information from the communication portion 402 via a communication channel 422. The decryption portion 406 receives information from the encrypted content storage 405 via a communication channel 424. Furthermore, the decryption portion 406 receives decryption key information from the decryption key portion 410 via a communication channel 428. The unencrypted content portion 408 receives information from the decryption portion 406 via a communication channel 426. The decryption key portion 410 receives information from the pre-rights generator storage 411 via a communication channel 430. The pre-rights generator storage 411 communicates bi-directionally with the processor portion 412 via a communication channel 432.

The processor portion 412 is arranged to bi-directionally communicate with the communication portion 402 via a communication channel 420. The processor portion 412 is arranged to bi-directionally communicate with the expiration timer 414 via a communication channel 434. The processor portion 412 is arranged to bi-directionally communicate with the user interface 416 via a communication channel 436.

The user interface 416 receives information from the unencrypted content portion 408 via a communication channel 438.

The communication portion 402 provides bi-directional communication between entities associated with the user device 106 and entities (not shown in FIG. 4) located external to the user device 106, such as the content providing device 102 and the credit managing device 104, via the communication channel 114. For example, requests for registering, downloading a movie and purchasing universal credit may be communicated to external entities via the communication portion 402. Furthermore, registration information, pre-rights generator information, and encrypted movies may be received from external entities via the communication portion 402.

The user device 106 provides management and delivery of content to a user. For example, a user may request and download a movie. Furthermore, a user may purchase a universal credit and consume the universal credit for purposes of viewing a movie.

The registering portion 403 provides registration capabilities via communication with external entities. For example, a user may seek to register via the registering portion 403 with a service providing movies for downloading and viewing.

The credit managing portion 404 provides management operations associated with a universal credit. For example, a user may purchase a universal credit via the credit managing portion 404 for purposes of viewing a movie from a service providing movies for downloading and viewing.

The encrypted content storage 405 provides storage of encrypted content. For example, the encrypted content storage 405 may provide storage for downloaded encrypted movies.

The decryption portion 406 provides decryption of encrypted content via a decryption key for delivery of unencrypted content. For example, the decryption portion 406 may decrypt an encrypted movie for viewing.

The unencrypted content portion 408 stores unencrypted content, received from the decryption portion 406, for delivery, such as display or audio play out, to a user of the user device 106. Non-limiting examples for content include movies, audio, pictures, images and books.

The decryption key portion 410 provides a key for decrypting encrypted content. For example, an encrypted movie may be decrypted via a decryption key provided by the decryption key portion 410.

The pre-rights generator storage 411 provides storage for a customer-specific pre-rights generator that may be received by the user device 106 from the content providing device 102. For example, the pre-rights generator storage 411 may store a pre-rights generator comprising a pre-rights generation file associated with performing pre-rights generation, for example, having key material for decrypting downloaded content, access rights for the content, and a price, or cost, of downloaded content. The pre-rights generator storage 411 assembles, and conveys to the content providing device 102, a key request, that is, a request for a key, which request includes content identification for requested content and an indicator specifying whether universal credit is consumed. In response to the key request, the pre-rights generator storage 411 receives a key reply. The key reply includes an identification of the content and rights associated with the content. For example, the associated rights may include a price of the content. The pre-rights generation file also includes a key list and a rights list. The key list includes a listing of keys. For example, the key list may include a decryption key for decryption of a movie for viewing by a user. The rights list includes content identification, associated rights and associated cost. The pre-rights generator file is protected during download via session keys. The pre-rights generator may expire following a pre-determined expiration time that may also be identified in the pre-rights generation file.

The processor portion 412 provides execution of operational codes for processing of information and management of the user device 106. The expiration timer 414 provides a timer for determining events associated with expiration. As an example, a downloaded movie may have a time limit for access and once the time limit has expired, the associated content stored by the user device 106 may no longer be accessible. The user interface 416 provides a means for a user to interface with the user device 106. For example, the user interface 416 may include a display screen, for example, a touchscreen, an audio interface, and a keyboard, that permit a user of the user device 106 to communicate with, and input instructions into, the user device, allowing the user to register with a movie downloading service, purchase a universal credit, download encrypted movies and consume a universal credit in order to view downloaded movies.

The digital rights management portion 417 performs Digital Rights Management (DRM) for content stored in the encrypted content storage 405. DRM is a term referring to access control methods used by copyright holders, media distribution outlets and publishers for restricting access to digital content and devices to entities which are authorized access. The DRM associated with a particular piece of digital data may provide: a set of access rights, e.g., can the receiver of the digital data access the digital data, and if so, how many times; and a set of copy rights, e.g., can the receiver of the digital data copy the digital data, and if so, how many times. DRM is deployed in order to prevent the unauthorized viewing, copying and/or distribution of digital content. Such rights may dictate whether (and how often) an entity may access content stored in the encrypted content storage 405. For example, a user may download a movie for viewing which has certain rights associated with the movie (i.e., an expiration time, a number of times allowed for viewing, etc.)

In operation, a user of the user device 106 inputs, into the user device and via the user interface 416, a request for access to content. The content access request is received by the processor portion 412 and the processor portion 412 communicates the content access request to the registering portion 403 via the communication channel 440. With additional reference to FIG. 1A, in response to receiving the content access request, the registering portion 403 communicates a registration request to the credit managing device 104 via the communication channel 444, the communication portion 402, the communication channel 114, the communications network 108 and the communication channel 112.

With additional reference to FIG. 3, the credit managing device 104 receives the registration request and routes the registration request to the registering portion 304 via the communication portion 302 and the communication channel 310.

Registration operation is performed by the registering portion 304 and communicated to the user device 106 via the communication channel 310, the communication portion 302, the communication channel 112, the communications network 108 and the communication channel 114.

Returning to FIG. 4, with additional reference to FIG. 1A, following registration, the user of the user device 106 may request to purchase universal credit from the credit managing device 104 via the user device. Non-limiting examples of ways to purchase universal credit include credit card, debit card and coupon. A universal credit purchase request is received by the credit managing device 104 via the user interface 416, and then conveyed to the credit managing device 104 via the communication channel 436, the processor portion 412, the communication channel 442, the credit managing portion 404, the communication channel 446, the communication portion 402, the communication channel 114, the communications network 108 and the communication channel 112.

Returning to FIG. 1A, with additional reference to FIG. 3, the credit managing device 104 receives the universal credit purchase request and routes the universal credit purchase request to credit managing portion 306 via the communication channel 312. Credit managing portion 306 performs a universal credit purchase request operation and communicates a universal credit to the user device 106 via the communication channel 312, the communication portion 302, the communication channel 112, the communications network 108 and the communication channel 114.

The user device 106 communicates the universal credit to the user interface 416, as shown in FIG. 4, via the communication channel 114, the communication portion 402, the communication channel 420, the processor portion 412 and the communication channel 436. Furthermore, the processor portion 412 maintains accounting information associated with universal credit.

The user of the user device 106 then may input, to the user device 106 via the user interface 416, a request for a download of encrypted content.

The request for a download of encrypted content is communicated to the content providing device 102 via the communication channel 436, the processor portion 412, the communication channel 420, the communication portion 402, the communication channel 114, the communications network 108 and the communication channel 110.

With reference to FIG. 2, the content providing device 102 receives the request for a download of encrypted content and the pre-rights portion 204 creates a pre-rights generator for the user device 106 that comprises a pre-rights generation file. The content providing device 102 then conveys the pre-rights generator to the user device 106 via the communication channel 214, the communication portion 202, the communication channel 110, the communications network 108, and the communication channel 114.

The user device 106 receives and processes the pre-rights generator for storage in the pre-rights generator storage 411, as shown in FIG. 4, via the communication channel 114, the communication portion 402, the communication channel 420, the processor portion 412 and the communication channel 432. The conveyance and storage of the pre-rights generator is performed universal credit-free, that is, no universal credit is consumed for receipt and storage of the pre-rights generator.

The content providing device 102 then conveys encrypted content from the encrypted content storage portion 210, as shown in FIG. 2, to the user device 106 via the communication channel 220, the communication portion 202, the communication channel 110, the communications network 108, and the communication channel 114.

The user device 106 receives and stores the encrypted content in the encrypted content storage 405, as shown in FIG. 4, via the communication channel 114, the communication portion 402 and the communication channel 422. The conveyance and storage of the encrypted content also is performed universal credit-free, that is, no universal credit is consumed for receipt and storage of the encrypted content.

After the receipt and storage of the pre-rights generator by the user device 106, the user of the user device is able to access the stored encrypted content. In order to access the stored encrypted content, the user inputs, into the user device via the user interface 416, a request for access to content. In response to receiving the request for access to content, the user device 106, and in particular the decryption key portion 410, retrieves the pre-rights generator from the pre-rights generator storage 411, generates a decryption key, and provides the decryption key to the decryption portion 406.

The decryption portion 406 receives the decryption key from the decryption key portion 410 via the communication channel 428 and receives the encrypted content from the encrypted content storage 405 via the communication channel 424. The decryption portion 406 decrypts the encrypted content by use of the decryption key to generate unencrypted content and conveys the unencrypted content to the unencrypted content portion 408 via the communication channel 426. The unencrypted content portion 408 delivers the unencrypted content to the user of the user device 106 via the user interface 416 and a portion of the universal credit maintained by the user device is consumed. That is, in response to the decryption of the stored encrypted content and the delivery of the decrypted content to the user of the user device 106, the user device consumes a portion of the universal credit by reducing the amount of the universal credit remaining available to the user. The amount by which the universal credit is consumed may vary per instance and may depend upon such factors as a pricing structure set by an operator of the content providing device 102 and/or the credit managing device 104 and the type of content delivered to the user device 106.

The user device 106, when having sufficient universal credit, may generate the decryption key associated with the decryption key portion 410 and the pre-rights generator storage 411 when the user device is not connected to the communications network 108, that is, when the user device is off-line, as described with reference to FIG. 1B. The universal credit may be consumed and accounted for by the user device 106.

Following the off-line delivery of content and universal credit consumption, when the user device 106 reestablishes communications with the communications network 108 as described with reference to FIG. 1A, the user device updates the credit managing device 104 with respect to the universal credit and via the communication channel 114, the communications network 108 and the communication channel 112. The update may include credit-related information as the amount of the universal credit that has been consumed and the remaining amount of the universal credit and may further include content-related information such as the content viewed and a number of times that the content has been viewed.

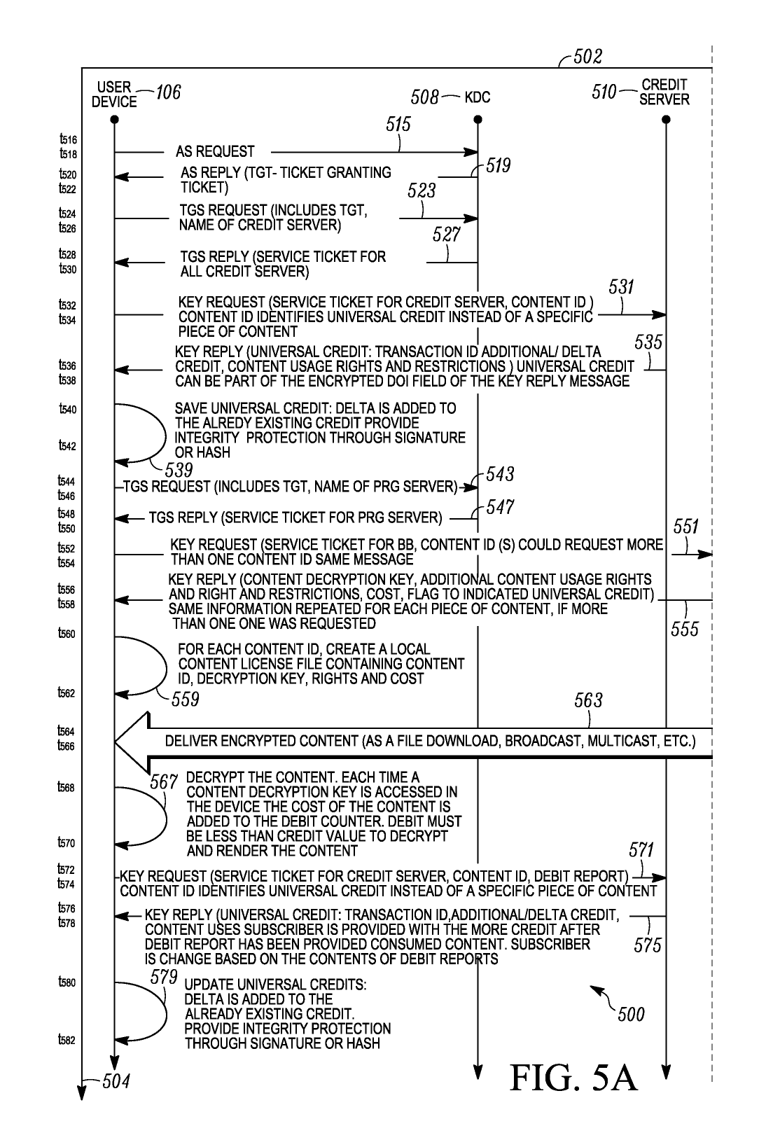

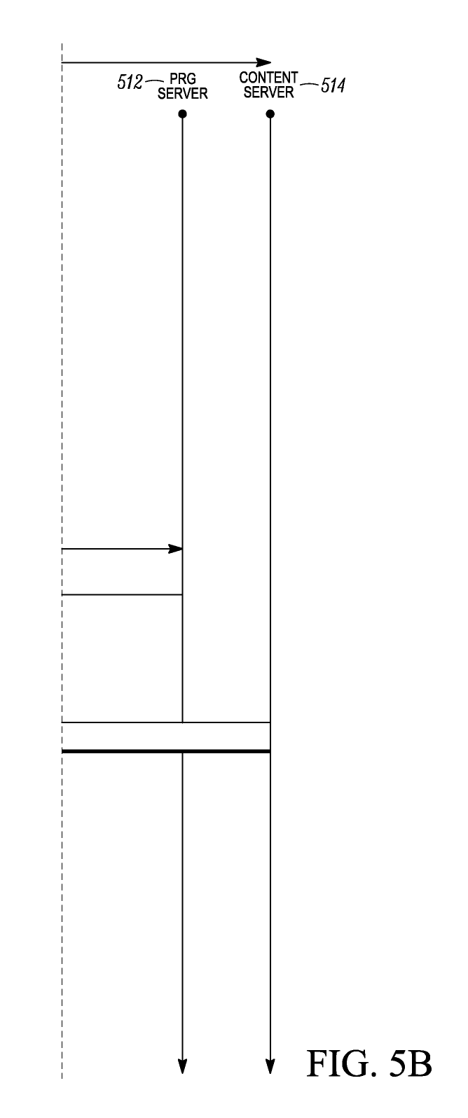

FIGS. 5A and 5B depict a signal flow diagram 500 illustrating event and communication timing for operations associated with universal credit and content access, in accordance with an aspect of the present invention. FIG. 5 is based on an example digital rights management system, for example as disclosed in U.S. Pat. No. 7,243,366 to Medvinsky et al., patented Jul. 10, 2007, the entire disclosure of which is incorporated herein.

Signal flow diagram 500 includes an x-axis 502 and a y-axis 504. The x-axis 502 represents activities associated with entities communicating with other entities and the y-axis 504 represents time.

Entities associated with x-axis 502 include the user device 106, a Key Distribution Center (KDC) 508, a credit server 510, a Program Rights Generator (PRG) server 512 and a content server 514. In this example, the entities of FIG. 5 correspond with the devices of FIGS. 1A-B. For example, the credit server 510 may correspond to the credit managing device 104, whereas the KDC 508, the PRG server 512 and the content server 514 may correspond to the content providing device 102. Further, in this example, some of the entities of FIG. 5 correspond with the devices of FIG. 2. For example, the PRG server 512 may correspond to the pre-rights portion 204 and the content server 514 may correspond to the content portion 206.

The KDC 508 provides authorization to request content decryption keys and rights. A ticket is an authorization token, provided by KDC 508, which includes a key. The credit server 510 performs operations associated with credit. The PRG server 512 provides information for viewing available content. The user device 106 receives a pre-rights generator from the PRG server 512.

A new customer seeking to purchase universal credit may purchase universal credit following registration. Non-limiting examples of ways for customer paying for universal credit include credit card, debit card and coupon. Alternatively, a customer may be extended universal credit following registration and may be billed for it at a later time, e.g., on a monthly basis.

In order for a new customer to register or periodically re-register, an Authentication Server (AS) request 515 is transmitted by the user device 106 at a time t₅₁₆ and is received by the KDC 508 at a time t₅₁₈.

AS request 515 operates to communicate a request for a Ticket Granting Ticket (TGT) from KDC 508. A ticket is used to securely pass to a server a session key, which is used for encrypting/decrypting communications associated with a KDC session, along with the identity of the client (that is, the user device 106 in signal flow diagram 500) for whom the ticket was issued. A ticket is tamperproof and can be safely stored by the clients, allowing servers to remain stateless (a server can re-learn the session key each time that the client passes it the ticket). A TGT is used by user device 106 to request tickets from KDC 508.

In response to receiving the AS request 515, the KDC 508 transmits an AS reply 519 at a time t₅₂₀ and the AS reply 519 is received by the user device 106 at a time t₅₂₂. The AS reply 519 communicates a TGT in response to AS request 515.

After receiving the AS reply 519, the user device 106 transmits a Ticket Granting Server (TGS) request 523 at a time t₅₂₄ and the TGS request 523 is received by the KDC 508 at a time t₅₂₆. The TGS request 523 includes a TGT and an identifier associated with credit server 510. The TGS request 523 requests a service ticket from KDC 508. User device 106 uses a service ticket in order to communicate with PRG server 512.

In response to receiving the TGS Request 523, the KDC 508 transmits a TGS reply 527 at a time t₅₂₈ and the TGS Reply 527 is received by the user device 106 at a time t₅₃₀. The TGS reply 527 includes service ticket information which user device 106 uses in order to communicate with PRG server 512.

After receiving the TGS reply 527, the user device 106 transmits a key request 531 at a time t₅₃₂ and the key request 531 is received by the credit server 510 at a time t₅₃₄. The key request 531 includes a service ticket for communicating with credit server 510 and a content identifier indicating a universal credit operation.

Following receipt of the key request 531, the credit server 510 processes payment for a universal credit and the request for a universal credit is accepted by the credit server 510. In response to receiving payment for the universal credit, the credit server 510 transmits a key reply 535 at a time t₅₃₆ and the key reply 535 is received by the user device 106 at a time t₅₃₈. Alternatively, credit is extended to the user after key request 531 is received (up to a predefined limit) and the user is billed at a later time.

The key reply 535 includes information associated with the universal credit including a transaction identification, which identifies the transaction, an additional/delta credit, which identifies an amount if additional/delta credit, a content usage rights and restrictions, which identifies usage rights/restrictions associated with content.

After to receiving the key reply 535, the user device 106 initiates saving, that is, storing, the universal credit at a time t₅₄₀ as noted by a save universal credit 539 and terminates saving universal credit at a time t₅₄₂. The save universal credit 539 stores the universal credit or, if there is any existing universal credit maintained at the user device 106, adds delta credit to the existing universal credit. Integrity protection is provided via a signature or hash. As a non-limiting example signature or hash may be a keyed checksum or a digital signature.

After completion of saving universal credit, the user device 106 transmits a TGS request 543 at a time t₅₄₄ and the TGS request 543 is received by the KDC 508 at a time t₅₄₆. The TGS request 543 includes the TGT and an identifier associated with a PRG server.

In response to receiving the TGS request 543, the KDC 508 transmits a TGS reply 547 at a time t₅₄₈ and the TGS reply 547 is received by the user device 106 at a time t₅₅₀. The TGS reply 547 includes a service ticket for PRG server 512.

After receiving the TGS reply 547, the user device 106 transmits a key request 551 at a time t₅₅₂ and the key request 551 is received by the PRG server 512 at a time t₅₅₄. The key request 551 includes a service ticket and content identifier or content identifiers.

A TGS request 543 may happen at any time between t₅₂₂ and t₅₅₂. For example the user device 106 may request a PRG Server ticket immediately after t₅₅₀. Further, the user device 106 may request a PRG Server ticket immediately after t₅₂₂.

In response to receiving the key request 551, the PRG server 512 transmits a key reply 555 at a time t₅₅₆ and the key reply 555 is received by the user device 106 at a time t₅₅₈. The key reply 555 includes content decryption key, additional content usage rights and restrictions, cost associated with content and an identifier indicating information associated with universal credit. The key reply 555 may include information associated with a multiplicity of content. Alternatively, the key reply 555 may include a secret key which is used to derive the content decryption key (instead of directly including a content decryption key). The information included in the key reply 555 is equivalent to a pre-rights generator.

After receiving the key reply 555, the user device 106 initiates creation of local content license file(s) at a time t₅₆₀ as noted by a create local content license file 559 and completes creation of local content license file(s) at a time t₅₆₂. Local content license file includes content associated identification, decryption key, rights information and cost.

Content, noted by a content delivery 563, is transmitted from the content server 514 at a time t₅₆₄ and the content delivery 563 is received by the user device 106 at a time t₅₆₆. As a non-limiting example, a movie may be downloaded from content server 514 to user device 106.

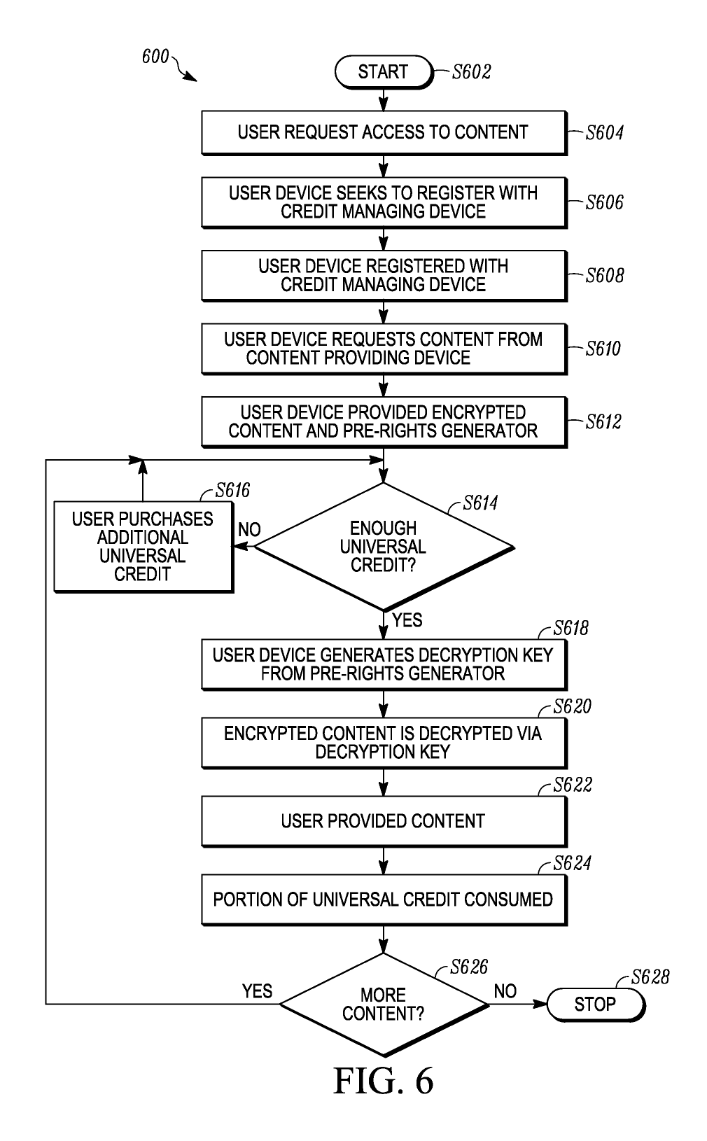

Decryption of content is initiated by the user device 106 at a time t₅₆₈ as noted by a content decryption 567 with decryption of content completed at a time t₅₇₀. It should be noted that there may be situations there is insufficient universal credit for universal device 106 to decrypt the content. In such cases, the user device 106 may need to revisit the credit managing device 104 to obtain additional universal credit, thus repeating steps 531, 535 and 539. This will be described in greater detail below with additional reference to FIG. 6.

Once sufficient content is obtained, for content which is decrypted, the cost associated with the content is added to a debit counter maintained by the user device 106. The debit counter is used for accounting for the total amount of content decrypted. The value of the debit counter must be less than the universal credit in order to perform decryption of the content.

A key request 571 is transmitted from the user device 106 at a time t₅₇₂ and the key request 571 is received by the credit server 510 at a time t₅₇₄. The key request 571 communicates a service ticket, content identification and a debit report associated with previously consumed content. The content identification identifies the communicated information as associated with universal credit.

In response to receiving the key request 571, the credit server 510 transmits a key reply 575 at a time t₅₇₆ and the key reply 575 is received by the user device 106 at a time t₅₇₈. The key reply 575 communicates information associated with the universal credit including transaction identification, additional/delta credit, and content usage rights and restrictions. The user device 106 may be provided with additional credit by the credit server 510 following receipt of the debit report.

After receiving the key reply 575, the user device 106 initiates updating the universal credit at a time t₅₈₀ as noted by an update universal credit 579 and completes the update of the universal credit at a time t₅₈₂.

The updating of the universal credit 579 updates the universal credit by adding the delta credit to the universal credit. Security of communication is provided via signature or a keyed hash. Signal flow diagram 500 then ends.

Referring now to FIG. 6, a logic flow diagram is provided that illustrates a method 600 for providing unencrypted content associated with a request for the content, in accordance with an embodiment of the present invention. The method 600 starts (S602) with a user requesting access to content (S604). For example, a user may input a request for content into the user device 106 via the user interface 416, as shown in FIG. 4. In an example embodiment, a user may seek to download a movie for potential viewing. For example, a user interfacing with a computing device may be searching the catalogue of a movie download service via the Internet for potential movies to view. Furthermore, following the user's discovery of a movie for viewing, the user then requests to download the movie via the user interface 416.

Returning to FIG. 6, when the user device 106 receives the request for content from the user, the user device registers with the credit managing device 104 (S606). For example, the user may seek to register with a movie download service for downloading movies for view and, correspondingly, the user device then registers with a credit managing device associated with the movie download service. That is, and referring again to FIG. 4, when the user device 106, and in particular the user interface 416, receives the registration request from the user, the user interface communicates the registration request to the processor portion 412 via the communication channel 436. The processor portion 412 then communicates the registration request to the registering portion 403 via the communication channel 440, and the registering portion 403 communicates registration request to the communication portion 402 via the communication channel 444. The communication portion 402 then conveys the registration request from the user device 106 to the communication portion 302, as shown in FIG. 3, of the credit managing device 104 via the communication channel 114, the communications network 108 and the communication channel 112.

In an alternative embodiment, the user device 106 may register with the credit managing device 104 ahead of time. This would avoid a delay at the time when the user device 106 requests specific content.

Returning to FIG. 6, the user device 106 then is registered with the credit managing device 104 (S608). Registration of the user device 106 provides the user device with access to content from the content providing device 102. Furthermore, registration provides the user device 106 with a capability to purchase a universal credit. For example, following registration a user may select to download a movie or movies to the user device 106 for potential viewing.

Following registration, the user of the user device 106 then may request a download of content from the content providing device 102 (S610). For example, the user may select to download a movie or movies to the user device 106 from the content providing device 102 for potential viewing. With reference to FIG. 4, the user inputs a content download request into the user interface 416, which content download request is routed to the processor portion 412 via the communication channel 436. The processor portion 412 routes the content download request to the communication portion 402 via the communication channel 420. The communication portion 402 then conveys the content download request to the communication portion 202, as shown in FIG. 2, of the content providing device 102 via the communication channel 114, the communications network 108 and the communication channel 110.

Returning to FIG. 6, the content providing device 102 receives the content download request and creates and conveys a pre-rights generator to the user device 106 and further conveys encrypted content to the user device 106 (S612). That is, and referring to FIG. 2, in response to receipt of the content download request, the communication portion 202 of the content providing device 102 receives a pre-rights generator from the pre-rights portion 204 via the communication channel 214 and receives encrypted content from the encrypted content storage portion 210 via the communication channel 220. The communication portion 202 of the content providing device 102 conveys the encrypted content to the encrypted content storage 405, as shown in FIG. 4, of the user device 106 via the communication channel 110, the communications network 108, the communication channel 114, the communication portion 402 and the communication channel 422, as shown in FIG. 4, and the user device 106 stores the encrypted content in the encrypted content storage 405. Furthermore, the communication portion 202 of the content providing device 102 conveys the pre-rights generator to the pre-rights generator storage 411 of the user device 106 via the communication channel 110, the communications network 108, the communication channel 114, the communication portion 402, the communication channel 420, the processor portion 412 and the communication channel 432, and the user device 106 stores the pre-rights generator in the pre-rights generator storage 411. For example, after registration and download of a movie or movies, a user may seek to view a movie. With sufficient credit, a user may view a downloaded movie. Additional credit may be purchased for viewing a movie for conditions of insufficient credit.

Returning to FIG. 6, the user device 106 then determines whether sufficient universal credit is available for purchasing content and whether the content may be accessed per digital rights (S614). That is, with reference to FIG. 4, the processor portion 412 of the user device 106 retrieves a cost of the content from the pre-rights generator storage 411 via the communication channel 432 and available universal credit from the credit managing portion 404. The processor portion 412 then performs a comparison, that is, compares the cost of the content and the amount of available universal credit to determine if sufficient universal credit is available for accessing the content. If sufficient universal credit is available for accessing the content, then the content may be accessed and logic flow diagram 600 proceeds to step S618. Furthermore, the processor portion 412 retrieves digital rights management information from the digital rights management portion 417 to determine if the content may be accessed per the digital rights. Furthermore, the processor portion 412 may retrieve expiration timer information from the expiration timer 414, if such timer information is provided, via the communication channel 434 for determining whether content may be viewed based upon an expiration date. If sufficient universal credit is available, the digital rights permit a viewing, and sufficient time exists to view the content, the processor portion 412 generates a decryption key from the pre-rights generator (S618) stored in the pre-rights generator storage 411.

As an example, suppose a downloaded movie costs $5 to view. When the available universal credit is $5 or more, the movie may be viewed. When the available universal credit is less than $5, the movie may not be viewed without purchasing additional credit. Furthermore, a movie may not be viewed if the number of views after viewing would violate the digital rights for the movie. For example, if a movie which can be viewed two times had already been viewed two times, then the movie could not be viewed again. By way of another example, a movie which can be viewed only one time, and had not been viewed previously, may be viewed. By way of still another example, a movie which had been downloaded for two months and which has an expiration time of one month, could not be viewed by a user, whereas, when such a movie had been downloaded for only one week, the movie could be viewed by a user.

Returning to FIG. 6, when the user device 106 determines that insufficient universal credit is available (S614), the user of the user device 106 may purchase additional universal credit (S616). That is, with reference to FIGS. 1, 3 and 4, when the user device 106 determines that insufficient universal credit is available, the user device notifies the user via the user interface 416, for example, by displaying a text message. In response, the user device 106 may receive from the user, via the user interface 416, a request to purchase universal credit. For example, the user may seek to view a movie costing $5, but only has $4 of universal credit. The user then may choose to purchase additional credit in order to have sufficient universal credit which is equal to, or greater than the cost of the movie.

The user device 106 then routes the request to purchase universal credit to the processor portion 412 via the communication channel 436, and the processor portion 412 routes the request to the credit managing portion 404 via the communication channel 442. The credit managing portion 404 of the user device 106 then conveys the request to purchase universal credit to the credit managing portion 306 of the credit managing device 104 via the communication portion 402, the communication channel 114, the communications network 108, the communication channel 112, the communication portion 302 and the communication channel 312. The credit managing portion 306 then grants the user of the user device 106 additional universal credit, for example, by charging a credit card that the user may have registered with the credit managing portion 306 or via an arrangement with the user to charge the user for universal credit purchases via the user's Internet service or wireless cellular phone service providers or by billing the user at a later time.

For example, the user may provide his or her credit card information either when first registering with the credit managing portion 306 or as part of each request to purchase universal credit as described with reference to FIGS. 5A and 5B. Following successful purchase of the additional universal credit, that is, granting, by the credit managing portion 306, of the user's request to purchase additional universal credit, the credit managing portion 306 informs the user of the additional universal credit by conveying a message informing of the granting of additional universal credit to the credit managing portion 404 of the user device 106 via the communication channel 312, the communication portion 302, the communication channel 112, the communications network 108, the communication channel 114, the communication portion 402 and the communication channel 446.

Referring now to FIGS. 4 and 6, in response to receiving the message informing of the granting of additional universal credit, the user device 106, and in particular the processor portion 412, adds the granted available universal credit to any available universal credit maintained by the credit managing portion 404 to produce a new amount of available universal credit and determines, by comparing the cost of the content to the new amount of available universal credit, that sufficient universal credit exists for delivering the content to the user of the user device 106 (S614). The processor portion 412 then retrieves digital rights management information from the digital rights management portion 417, may retrieve expiration timer information from the expiration timer 414, if such timer information is provided, and, and assuming that digital rights permit a viewing and sufficient time exists to view the content, generates a decryption key from the pre-rights generator (S618) stored in the pre-rights generator storage 411.

Returning to FIG. 6, in response to generating a decryption key from the pre-rights generator at step S618, the user device 106 then decrypts encrypted content via the decryption key (S620). For example, an encrypted movie is decrypted using a decryption key. That is, with reference to FIG. 4, the decryption portion 406 retrieves the encrypted content stored in the encrypted content storage 405 from the encrypted content storage via the communication channel 424. The decryption portion 406 decrypts the encrypted content using the decryption key received from the decryption key portion 410 via the communication channel 428 and stores the decrypted content in the unencrypted content portion 408 via the communication channel 426.

Returning to FIG. 6, the user device 106 then provides the user of the user device with unencrypted content via the user interface 416 of user device (S622). That is, with reference to FIG. 4, the user then views the unencrypted content via the user interface 416, received from the unencrypted content portion 408 via the communication channel 438.

In exchange for delivery of unencrypted content to the user, a portion of the universal credit is consumed (S624). That is, returning to FIG. 4, in response to providing the user of the user device 106 with unencrypted content via the user interface 416, the processor portion 412, by way of the communication channel 442, instructs the credit managing portion 404 to debit or decrement the available universal credit by an amount associated with the cost of provided content. For example, for a cost of viewing a movie of $5, the available universal credit is decremented by $5. Furthermore, a universal credit of $9 prior to watching a movie is configured for $4 after user watches a $5 movie.

Returning to FIG. 6, a determination then may be performed as to whether user seeks additional content (S626). That is, the user of the user device 106 may input, into the user device via the user interface 416, an indication of desire to receive or to not receive additional content. When the user indicates a desire to receive additional content, execution of the method 600 returns to block (S614), that is, verification of sufficient universal credit. When the user indicates a desire to not receive additional content, execution of the method 600 terminates (S628).

FIG. 6 illustrates a method for providing a communication system for delivery of content to a user device. The user device 106 may download encrypted content prior to consuming universal credit. A pre-rights generator may be created and used for generating a decryption key. Decryption key may be used for decrypting encrypted content. The user device 106 then may deliver unencrypted content, with sufficient universal credit, while connected to a communications network and also while not connected to a communications network with update of universal credit accounting performed after reconnecting with a communications network. For example, a movie or movies may be downloaded for viewing with sufficient credit at a convenient time. Additional credit may be purchased for a condition of insufficient credit. A user may view downloaded movies with sufficient credit when user device is connected or not connected to a communication network.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method of transferring content within a system having a credit managing device, a content providing device and a user device, said method comprising:
registering the user device with the credit managing device;
providing a universal credit to the user device from the credit managing device based on said registering the user device with the credit managing device;
providing encrypted content and a pre-rights generator from the content providing device to the user device at a first time without consuming the universal credit;
generating a decryption key from the pre-rights generator a second time after the first time; and
decrypting, via the decryption key, the encrypted content at the user device and consuming a portion of the universal credit.

2. The method of claim 1, wherein said providing a universal credit to the user device from the credit managing device based on said registering the user device with the credit managing device comprises providing the universal credit having encrypted entitlement rights.

3. The method of claim 2, wherein said providing the universal credit having encrypted entitlement rights comprises providing the universal credit having encrypted entitlement rights indicating at least one of a predetermined number of permitted copies of content to be purchased, a predetermined number of permitted viewings of the content to be purchased and a predetermined number of moves of the content to be purchased.

4. The method of claim 1, wherein said providing encrypted content and a pre-rights generator from the content providing device to the user device at a first time comprises providing the pre-rights generator to indicate at least one of an expiration time of the pre-rights generator.

5. The method of claim 1, further comprising:
providing second encrypted content and a second pre-rights generator from the content providing device to the user device at a third time without consuming the universal credit;
generating a second decryption key from the second pre-rights generator;
decrypting, via the second decryption key, the second encrypted content at the user device a fourth time after the third time and consuming a second portion of the universal credit.

6. The method of claim 5, wherein said providing second encrypted content from the content providing device to the user device at a third time comprises providing a pre-rights generator indicating at least one of an expiration time of the second encrypted content and a price of decrypted second content corresponding to the second encrypted content with respect to the universal credit.

7. The method of claim 1, wherein said providing a universal credit to the user device from the credit managing device based on said registering the user device with the credit managing device comprises:
transmitting a key request from the user device to the credit managing device to obtain additional universal credit, the key request containing service ticket information; and
processing payment for the additional universal credit, via the credit managing device.

8. The method of claim 7, wherein said providing encrypted content and a pre-rights generator from the content providing device to the user device at a first time without consuming the universal credit comprises transmitting a key reply from the content providing device to the user device, the key reply including a content decryption key, content usage rights and restrictions, costs associated with the content and an identifier indicating information associated with the universal credit.

9. A device for use with a credit managing device and a content providing device, said device comprising:
a communication portion operable to communicate with the credit managing device and the content providing device;
a registering portion operable to register with the credit managing device via said communication portion;
a credit managing portion operable to receive a universal credit from the credit managing device via said communication portion;
a secure content portion operable to receive encrypted content and a pre-rights generator from the content providing device, via said communication portion, at a first time without consuming the universal credit; and
a decryption portion operable to generate a decryption key based the pre-rights generator,
wherein said decryption portion is further operable to decrypt, via the decryption key, the encrypted content at a second time after the first time and consume a portion of the universal credit.

10. The device of claim 9, wherein said credit managing portion is further operable to receive the universal credit so as to include encrypted entitlement rights.

11. The device of claim 10, wherein said credit managing portion is further operable to receive the universal credit so as to include encrypted entitlement rights indicating at least one of a predetermined number of permitted copies of content to be purchased, a predetermined number of permitted viewings of the content to be purchased and a predetermined number of moves of the content to be purchased.

12. The device of claim 11, wherein said decryption portion is further operable to decrypt the universal credit with the decryption key.

13. The device of claim 10, wherein said decryption portion is further operable to decrypt the universal credit with the decryption key.

14. The device of claim 9, wherein said decryption portion is further operable to decrypt the universal credit with the decryption key.

15. A computer-readable media having computer-readable instructions stored thereon, the computer-readable instructions being capable of being read by a computer to transfer content within a system having a credit managing device, a content providing device and a user device, the computer-readable instructions being capable of instructing the computer to perform the method comprising:
registering the user device with the credit managing device;
providing a universal credit to the user device from the credit managing device based on said registering the user device with the credit managing device;
providing encrypted content and a pre-rights generator from the content providing device to the user device at a first time without consuming the universal credit;
generating a decryption key from the pre-rights generator a second time after the first time; and
decrypting, via the decryption key, the encrypted content at the user device and consuming a portion of the universal credit.

16. The computer-readable media of claim 15, the computer-readable instructions being capable of instructing the computer to perform said method wherein said providing a universal credit to the user device from the credit managing device based on said registering the user device with the credit managing device comprises providing the universal credit having encrypted entitlement rights.

17. The computer-readable media of claim 16, the computer-readable instructions being capable of instructing the computer to perform said method wherein said providing the universal credit having encrypted entitlement rights comprises providing the universal credit having encrypted entitlement rights indicating at least one of a predetermined number of permitted copies of content to be purchased, a predetermined number of permitted viewings of the content to be purchased and a predetermined number of moves of the content to be purchased.

18. The computer-readable media of claim 15, the computer-readable instructions being capable of instructing the computer to perform said method wherein said providing encrypted content and a pre-rights generator from the content providing device to the user device at a first time comprises providing the pre-rights generator to indicate at least one of an expiration time of the pre-rights generator.

19. The computer-readable media of claim 15, the computer-readable instructions being capable of instructing the computer to perform said method further comprising:
providing second encrypted content and a second pre-rights generator from the content providing device to the user device at a third time without consuming the universal credit;
generating a second decryption key from the second pre-rights generator;
decrypting, via the second decryption key, the second encrypted content at the user device a fourth time after the third time and consuming a second portion of the universal credit.

20. The computer-readable media of claim 19, the computer-readable instructions being capable of instructing the computer to perform said method wherein said providing second encrypted content from the content providing device to the user device at a third time comprises providing a pre-rights generator indicating at least one of an expiration time of the second encrypted content and a price of decrypted second content corresponding to the second encrypted content with respect to the universal credit.
